(19) United States
(12) Patent Application Publication
(10) Pub. No.: US 2005/0207693 A1
(43) Pub. Date: Sep. 22, 2005

(54) Optical structures and methods for connecting optical circuit board components

(76) Inventor: Kishio Yokouchi, San Jose, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 10/805,825

(22) Filed: Mar. 22, 2004

(51) Int. Cl. G02B 6/12

(52) U.S. Cl. 385/14

(57) ABSTRACT

The present invention is directed to structures and methods of manufacturing such structures for providing optical connections between spaced-apart, opposing surfaces of substrates having optically active areas, that are compatible with semiconductor processing steps. An optical polymer layer is provided between opposing surfaces of a substrate and component or between two substrates to allow optical signals to pass therebetween and to bond the opposing surfaces. In one embodiment, the waveguide is formed from a photosensitive polymer that is patterned, cured and etched to provide the optical connection. In another embodiment, a photobleachable polymer is cured by light through a connected waveguide to provide a waveguide core.

### FIELD OF THE INVENTION

This invention is related to interconnecting optical devices. In particular, the present invention is directed to devices and methods for optically connecting electronic components and optical circuit boards.

### BACKGROUND OF THE INVENTION

The growth of networks capable of handling high data-rate transfer of voice and data has created a demand for optical networks. While information can be transferred optically over large distances, there is also a need for interfacing the optical portion of an optical network with electrical and electro-optical components. Thus for example, optical networks include amplifiers for strengthening optical beams, switches for routing signals, and conversions between electrical and optical signals at either end of the network. These functions are performed by devices that include optical, electro-optical and electrical components.

As with electronic devices, it is advantageous to arrange optical and electro-optical components in a chip-like configuration that allows for interconnection between devices. Numerous techniques have been proposed for the interconnection of optical beams of integrated circuit chips. Known methods and structures have problems in aligning or losses in the transmission of the optical beam, or are expensive or difficult to produce or use. Problems also arise when attempting to scale the proposed structures and methods to accommodate a large number of optical beams.

Therefore, it would be desirable to have an optical interconnect and method that provides a structure that is compatible with existing interconnect and processing technologies, corrects for slight misalignments between the components, has minimal or no optical loss, is relatively insensitive to misalignment, and can be easily scaled to devices that transmit many optical beams. It is also desirable to have an optical connection and method that does not require extensive processing of the chips, and that is reliable and relatively inexpensive.

### SUMMARY OF THE INVENTION

The present invention provides optical interconnections and methods for providing optical interconnections between two substrates having optically active areas, such as between an optical circuit board and an IC. As used herein the term “optically active” areas, means an area on a substrate where light is transmitted or received, and includes waveguide ends and active optical devices such as semiconductor lasers, photodiodes, light emitting diodes, and the like.

One aspect of the present invention is to provide a device and method for optically connecting two substrates wherein opposing surfaces of the substrates are parallel and spaced apart, and separated by an optical polymer. Optional members placed between the components can be embedded within the optical polymer or adjacent to the optical polymer, and can provide mechanical support and/or electrical connections between the components.

It is one aspect of the present invention to provide an apparatus for transmitting light between optically active areas on opposing, spaced apart surfaces on two substrates using a polymeric waveguide in the space between the two substrates. The polymeric waveguide has a core and a cladding. In one embodiment, the polymer of the core comprises a photosensitive polymer, such as a polymeric photoresist. In another embodiment, the polymer is a photobleachable polymer, and the core is bleached to have a different refractive index than the surrounding area which serves as the cladding polymer. One of the substrates may be an optical circuit board and the other may be an IC chip having optically active areas.

It is another aspect of the present invention to provide a method of forming an optical interconnect between optically active areas on opposing and spaced-apart substrates. The method comprises the steps of forming waveguide cores on the active areas on one substrate from a photosensitive polymer, where the cores protrude from the substrate and have distal ends, forming a waveguide cladding surrounding the waveguide core from a second polymer, and joining the second substrate to the waveguides after aligning the optically active areas.

In another embodiment of the present invention, forming the waveguide core includes coating at least a portion of one of the substrates overlying optically active areas with a photosensitive polymer, paritally curing the polymer, exposing the polymer to patterned actinic radiation at positions corresponding to the optically active areas, and selectively etching away the unexposed portions of the polymer.

In another embodiment of the present invention, forming the waveguide cladding includes coating at least a portion of the substrate surrounding the waveguide cores with the second polymer; and curing the second polymer. A further aspect of the present invention comprises polishing the exposed surfaces of the interconnect polymers.

It is yet another aspect of the present invention to provide a method of forming an optical interconnect between optically active areas on opposing and spaced apart substrates, comprising depositing a photobleachable polymer on the substrate to cover at least the optically areas on one of the substrates, partially curing the polymer, emitting actinic radiation from the optically active areas on the substrate to modify the refractive index of the polymer, and then curing the polymer.

These features, together with the various ancillary provisions and features which will become apparent to those skilled in the art from the following detailed description, are attained by the optical interconnection structures and methods of manufacturing such structures of the present invention, preferred embodiments thereof being shown with reference to the accompanying drawings, by way of example only.

### BRIEF DESCRIPTION OF DRAWINGS

The foregoing aspects and the attendant advantages of this invention will become more readily apparent by reference to the following detailed description when taken in conjunction with the accompanying drawings wherein:

FIG. 1 is a schematic plan view of a substrate having an integrated optical waveguide with optical components mounted thereon;

FIGS. 2A and 2B are schematic cross-sectional views 2-2 of FIG. 1 illustrating two alternative embodiments of the present invention;

FIG; 3 is a schematic cross-sectional side view 3-3 of FIG. 1 showing an embodiment of the present invention having electrical connections embedded in the layer;

FIG. 4 schematic cross-sectional view illustrating an embodiment of the present invention;

FIG. 5 schematic cross-sectional view illustrating another embodiment of the present invention;

FIG. 6A-6D are schematic cross-sectional views illustrating additional embodiments of the present invention;

FIGS. 7A-7E are schematic cross-sectional views illustrating a method for manufacturing the embodiment of FIG. 4;

FIGS. 8A-8D are schematic cross-sectional views illustrating an alternative method for manufacturing the embodiment of FIG. 4;

FIGS. 9A-9E are schematic cross-sectional views illustrating a method for manufacturing the embodiment of FIG. 5; and

FIGS. 10A-10D are schematic cross-sectional views illustrating a method for manufacturing the embodiment of FIG. 6.

Reference symbols are used in the Figures to indicate certain components, aspects or features shown therein, with reference symbols common to more than one Figure indicating like components, aspects or features shown therein.

### DETAILED DESCRIPTION

The present invention is directed to optical interconnect structures, and method of manufacturing such structures, for connecting active optical components, such as photodiodes, lasers, light emitting diodes and the like, that are mounted or formed on different substrates. An IC may incorporate a plurality of such active optical components, in addition to electrical components, and the light path between active components often includes one or more waveguides formed in one or both of the substrates, to passively route light between a waveguide input and output.

According to the present invention the structures and methods for optically connecting optically active areas on opposing substrates use optical polymers. Suitable useful optical polymer materials are well-known in the art and include such materials as polyurethane, polycarbonate, acrylic polymer, and vinyl polymer. Acrylic polymers such as polymers of methacrylamides or polymers of alkyl-methacrylates such as polymethyl-methacrylate (PMMA) are useful at short wavelengths near the visible region. One type of optical polymer useful in this invention is a “photosensitive” or “photodefinable” polymer, such as certain polyimides, that may be patterned by exposure to actinic radiation, usually ultraviolet (UV) light. Photosensitive polymers are used to form solid features by exposing portions of the polymer to a pattern of UV light, where the pattern corresponds to a desired pattern of solid polymer. The photosensitive polymer cures according to the exposure of UV light, and the unexposed polymer is then etched away to leave the desired polymer pattern.

Another type of optical polymer useful in this invention is a “photobleachable” polymer. The term photobleachable polymer, as used herein, generally refers to a polymer that undergoes a change in one or more optical properties, such as index of refraction, when exposed to actinic radiation, such as UV light. A photobleachable polymer may incorporate, for example, a dye in a liquid polymer, where the dye undergoes chemical changes resulting from absorption of actinic radiation that modify the properties of the polymer/dye mixture. A photobleachable polymer may to used to create a pattern of differing refractive index polymer by photobleaching and curing the polymer in selected regions.

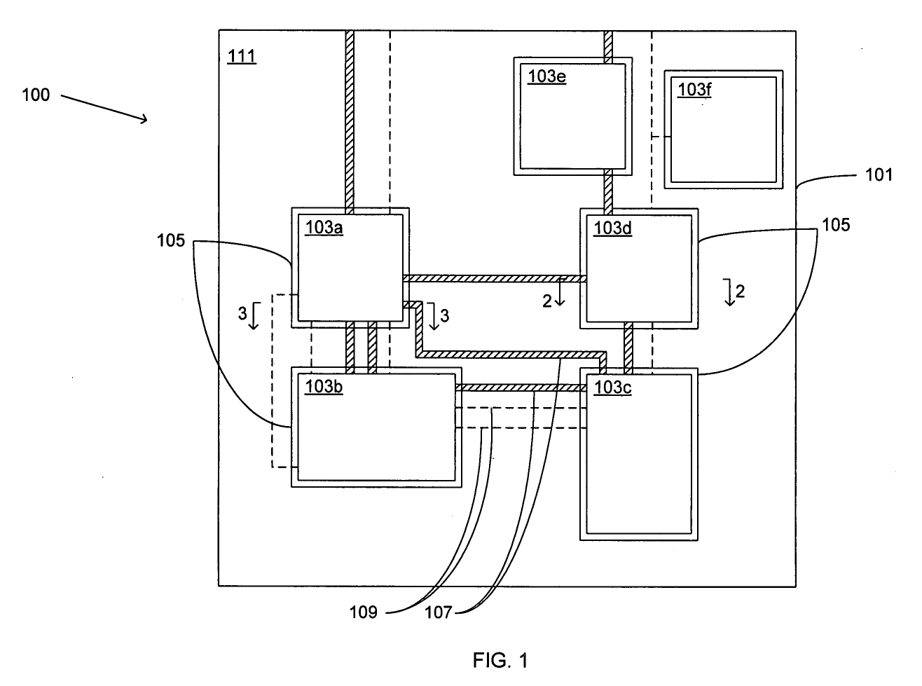

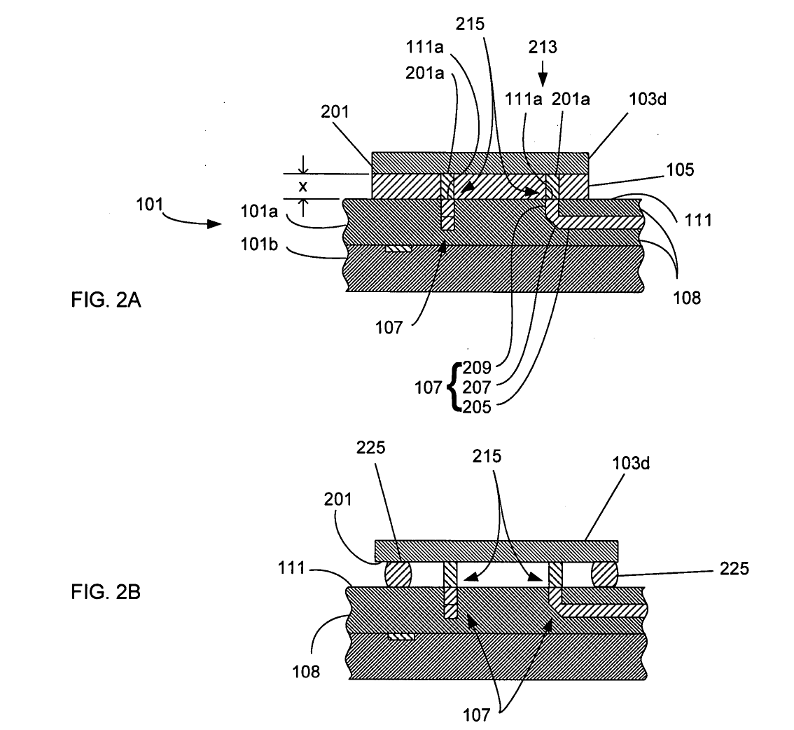

The present invention will initially be discussed by referring to FIGS. 1 and 2, showing, respectively, a schematic plan view of an integrated circuit (IC) package 100, that includes optical components, and sectional side views 2-2 of FIG. 1 of two specific embodiments of the present invention. IC package 100 includes an optical substrate 101 on which ICs or similar devices 103 are mounted. In general, optical substrate 101 can be a multilayer substrate, such has a multi-layer printed circuit board having at least one optical layer 101a comprising waveguides for routing light therein, and may also include active optical devices such as photodiodes, semiconductor lasers and light emitting diodes. As used herein the term “optical substrate” means a substrate for mounting a plurality of active devices, such as IC's, which has optically active areas and structure for routing light beams between the active devices, or between one or more individual active devices and components that are external to the optical circuit board.

Devices 103 are mounted on substrate 101 and include one or more electrical, optical, or electro-optical components that communicate with other devices mounted on substrate 101 or external thereto, using optical and/or electrical signals that are transmitted via pathways formed within or on substrate 101. Thus, in the preferred embodiments of the present invention, substrate 101 is a multilayer substrate having at least one optical layer 101a, for routing optical signals and at least one electrical layer 101b, for routing electrical signals and/or to supply electrical power to devices 103. Layer 101a includes one or more optical waveguides 107. Layer 101b includes one or more conductive paths 109.

As shown in FIG. 1, devices 103 are arranged on top of electrical conductors 109 and optical waveguides 107 with connections made between the devices and one or more of the conductors and waveguides, as necessary. For example, components 103a, 103b, 103c, and 103d are positioned over both conductors 109 and waveguides 107, component 103e is positioned only over a waveguide, and component 103f is positioned only over a conductor.

In the illustrated embodiments, one of the substrates is an IC device, and the other substrate is a optical circuit board on which one or more IC devices are mounted. However, it is not intended that the invention be limited to such combinations. Those skilled in the art will appreciate that the optical interconnect structures of the present invention are useful for making connections between an IC chip, or similar device, mounted directly on another IC or on an “interposer” substrate positioned between an IC chip and an optical circuit board, or for making connections between two optical circuit boards. In general, the present invention is used for forming optical connections between optically active areas on opposing surfaces of two substrates, for example, in a “flip-chip” configuration, and the method of the present invention is compatible with such mounting technologies.

Two embodiments of the present invention are shown in FIGS. 2A and 2B. Optical circuit board 101 has a surface 111 with one or more optically active areas 111a that accept or project light in a direction that is generally perpendicular to the substrate surface. In the embodiment of FIG. 2A, waveguide 107 includes a first waveguide portion 205 within the plane of layer 101a, a second waveguide portion 209 perpendicular to the first waveguide, and an angled portion 207 for redirecting light between the first and second waveguide portions. Waveguide 107 is surrounded by a cladding 108 having a different refractive index than the waveguides according to well know optical principles. Device 103d has a surface 201 with optically active areas 201a aligned with areas 111a. Opposing surfaces 201 and 111 are generally parallel and separated by the distance denoted “x”, such that they form a pair of opposing and spaced apart surfaces. In operation of an optical circuit, optical signals are transmitted between optically active areas on the opposing substrate surfaces. In the illustrated embodiment, optically active areas 111a serve as inputs and outputs to waveguides 107. The present invention is useful for a wide range of spacing between surfaces 201 and 111. The distance x can be from about 0.02 mm to about 0.15 mm, and is preferably between about 0.05 mm to about 0.10 mm.

In FIG. 2A a polymer layer 105 is disposed between surfaces 111 and 201, and includes a waveguide 215 of an optical polymer between each opposing pair of optically active areas. Layer 105 of the present invention may fill the entire volume between surfaces 111 and 201. In FIG. 2A, layer 105 comprises a waveguide core 215 formed from an optical polymer that extends between the optically active areas on opposing surfaces surrounded by a waveguide cladding 216, preferably also an optical polymer, and that surrounds core material 221. As depicted, cladding material 216 substantially fills the remaining volume between surfaces 111 and 201. As is well known to those skilled in the art, the core and cladding materials have different refractive indices to provide light confinement in the waveguide. Waveguides 215 thus provide a path for transmitting light through layer 105 and between each pair of opposing optically active areas 111a and 201a.

In FIG. 2B, polymeric waveguides 215 fill a portion of the volume between surfaces 111 and 201, specifically, the portions between optically active areas 111a and 201a. If the area surrounding waveguides 215 have a different index of refraction, as when, for example, the remaining space is filled with a gas or is a vacuum, there is no need for a cladding material. Waveguides 105 only cover a portion of surface 201. In this case, optional elements 225 provide additional mechanical support to connected component 103 and substrate 101. Elements 225 can be solder balls or other mechanical supports, and may also provide electrical connection between surfaces 111 and 201.

FIG. 3 illustrates a device 103a that is both optically and electrically connected to circuit board 101. Optical connection is made in the same manner as previously described in reference to FIG. 2A. Electrical connection is made using know structures, such as solder bumps or posts that are formed first and, thereafter, become embedded in layer 105. (Only one such electrical connection is shown in FIG. 3.) A conductive path in layer 101b terminates at pad 109. A via 301 extends between pad 109 and an electrically active area 111b on surface 111. Device 103a has an electrically active area 201b of surface 201 that opposes an electrically active area 111b. Layer 105 thus has an embedded electrical interconnect element 303 to provide an electrical connection between optical circuit board substrate 101 and device 103a.

The space between opposing surfaces 111 and 201 may incorporate other elements embedded within layer 105 that are attached to substrate 101 and component 103 to provide physical support without providing electrical or optical connection between the substrates. Layer 105 may be deposited, glued, or otherwise adhered to one or both of the substrate and component. While FIGS. 2A and 3 show layers 105 which occupy the entire space between the opposing substrates, such a layer may occupy less than the entire space.

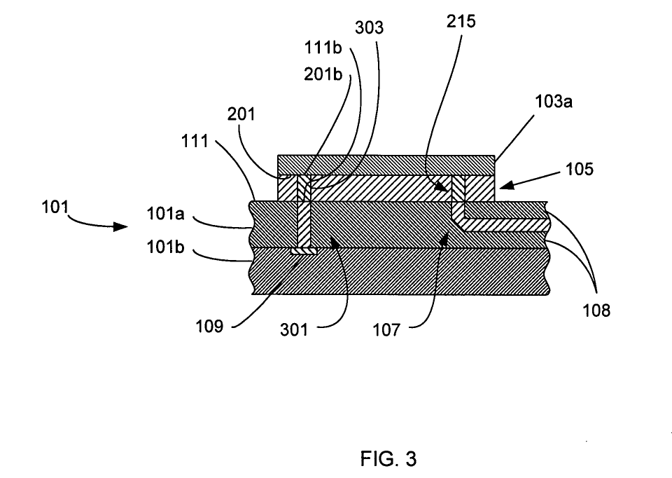

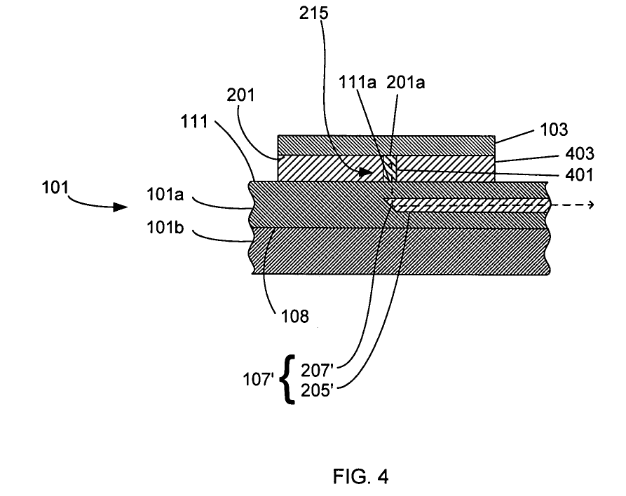

Several additional optical interconnect embodiments will now be discussed with reference to FIGS. 4, 5, and 6. FIG. 4 is a schematic cross-sectional view of a first embodiment optical connection formed in a layer 105 between device 103 and substrate 101 having an optical layer 101a with a waveguide 107′. Layer 105 include an optical waveguide 215, as described above. Waveguide 107′ of FIG. 4 has a different structure than the waveguides 107 of FIGS. 2 and 3. Waveguide 107′ includes a waveguide core 205′ having an angled portion 207′ surrounded by an optically transparent cladding 108. Because the light reflected by angled portion 207′ strikes the boundary between the core and the cladding substantially normal to the boundary interface, the light passes through the boundary into the cladding and propagates to optically active area 111a. Thus, while the cladding material confines light which is propagating generally parallel to the longitudinal direction of the waveguide, it is transparent to light which travels normal to the interface boundary. Thus, in this embodiment no specific structure is created in waveguide 107′ to route light between angled portion 207′ and optically active area 111a on the surface of optical circuit board 101. While the lack of a specific confinement structure may result in slightly greater light dispersion, the light path in the vertical direction is very short, and in most cases it is not necessary to include an additional structure.

Layer 105 of the FIG. 4 embodiment comprises a core material 401 and a cladding material 403. The configuration and optical properties of materials 401 and 403 cooperate to form waveguide 215 between each pair of opposing surfaces 213. Core material 401 extends between and substantially covers each pair of opposing optically active surfaces on device 103 and substrate 101. Cladding material 403 substantially fills the remaining space between component 103 and substrate 101, surrounding core 401. It is preferred that core material 401 and cladding material 403 are formed from optical polymers, and that there is a change in refractive index at the interface between core 401 and cladding 403. The change in refractive index may either be a step change or a gradual change, as in a graded-index waveguide. The selection of optical properties of core material 401 and cladding material 403 to form a waveguide is well known in the art.

In one embodiment of the present invention, core material 401 is a photosensitive polymer, and cladding material 403 is a heat-curable polymer. Preferred photosensitive polymers include, but are not limited to, fluorinated optical polymers such as Ultradel, a polymer including a fluorinated polyimide (Amoco), XU 35121, a polymer including perfluorocyclobutene (Dow Chemical), and fluorinated polymers manufactured by Hitachi Chemical. Preferred heat-curable polymers include V259EH available from Nippon Steel Chemical Co., Ltd.

In an alternative embodiment, core material 401 and cladding material 403 are formed from the same photobleachable polymer, where a defined area of layer 105 is photobleached to change its refractive index, thereby creating, in one step, a layer having defined areas of differing indices of refraction. In this embodiment core material 401 differs from cladding material 403 only by virtue of the fact that the core material has been irradiated with actinic radiation and, thereby, undergone a change in its index of refraction. Preferred photobleachable polymers include, but are not limited to, dye-doped polymers such as P2ANA, a PPMA copolymer (Hoechst Celanese), Glasia, a photosensitive polysilane (Nippon Paint), and the polymer PMMA doped with the dye 4-(dicyanomrthylene)-2-methyl-6-(p-dimethylaminostyl)4Hpyran, as described in Opt. Eng. 39(3), March, 2000.

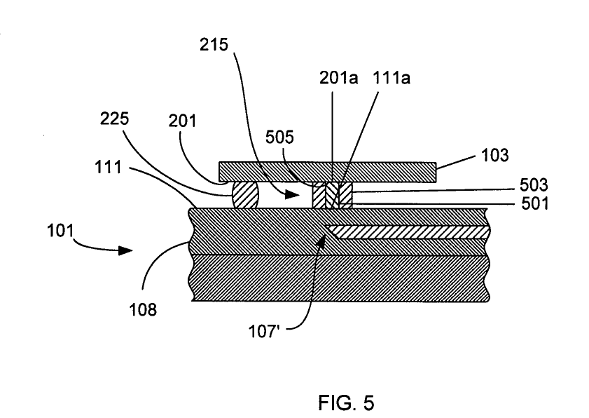

FIG. 5 is a sectional view of another embodiment of an optical connection between substrates. Substrate 101 is similar to the substrate of FIG. 4, having a waveguide 107′. A waveguide 215 transmits light between the substrates. In this embodiment, individual waveguides 215 are formed between the opposing optically active areas on the two substrates. Each waveguide 215 includes a core material 501 formed from an optical polymer, and a cladding material 503 that is also, preferably, formed from an optical polymer. The waveguide are first formed on one of the substrates and an adhesive 505 may then be used to join the other substrate to the exposed surface of the waveguide. Preferably, first and second materials 501 and 503 are cured polymers. In one embodiment, first material 501 is a photosensitive polymer, and that second material 503 is a heat-curable polymer. Preferred polymers are the same as those previously discussed.

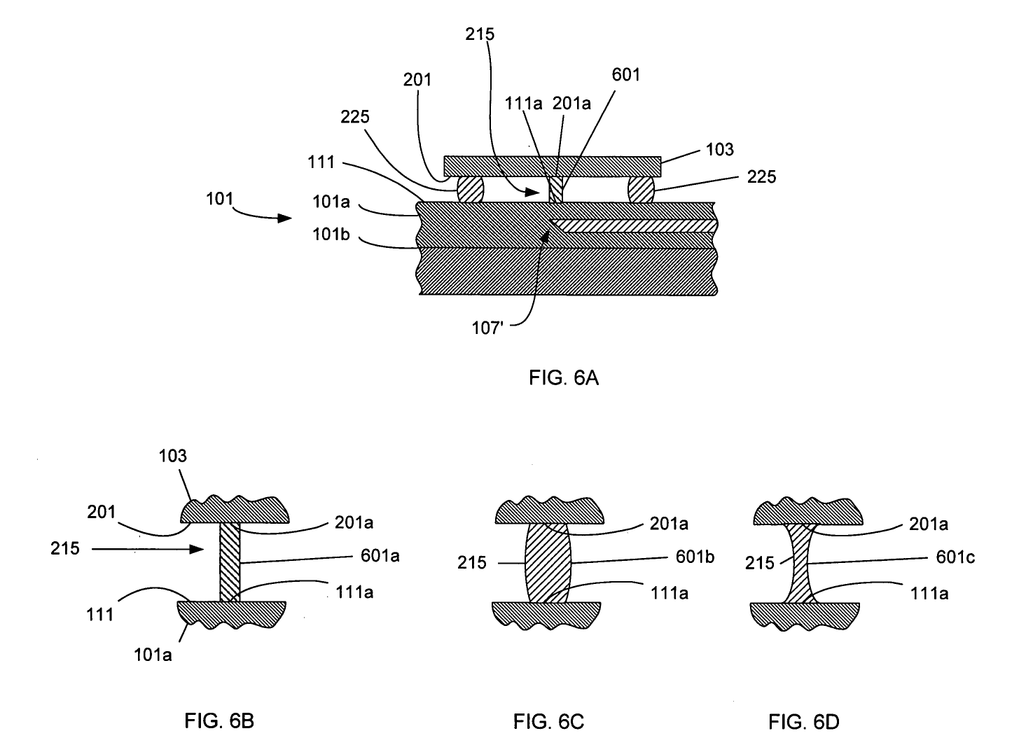

FIG. 6A shows yet another embodiment of the present invention, having a waveguide 215 formed of a material 601 extending between opposing optically active areas on two substrates. Preferably material 601 is a photobleachable polymer, that has been photobleached to induce a change in refractive index in the central portion thereof. Suitable photobleachable polymers have previously been described. Alternative shapes of waveguide 215 shown in more detail in FIGS. 6B-6D.

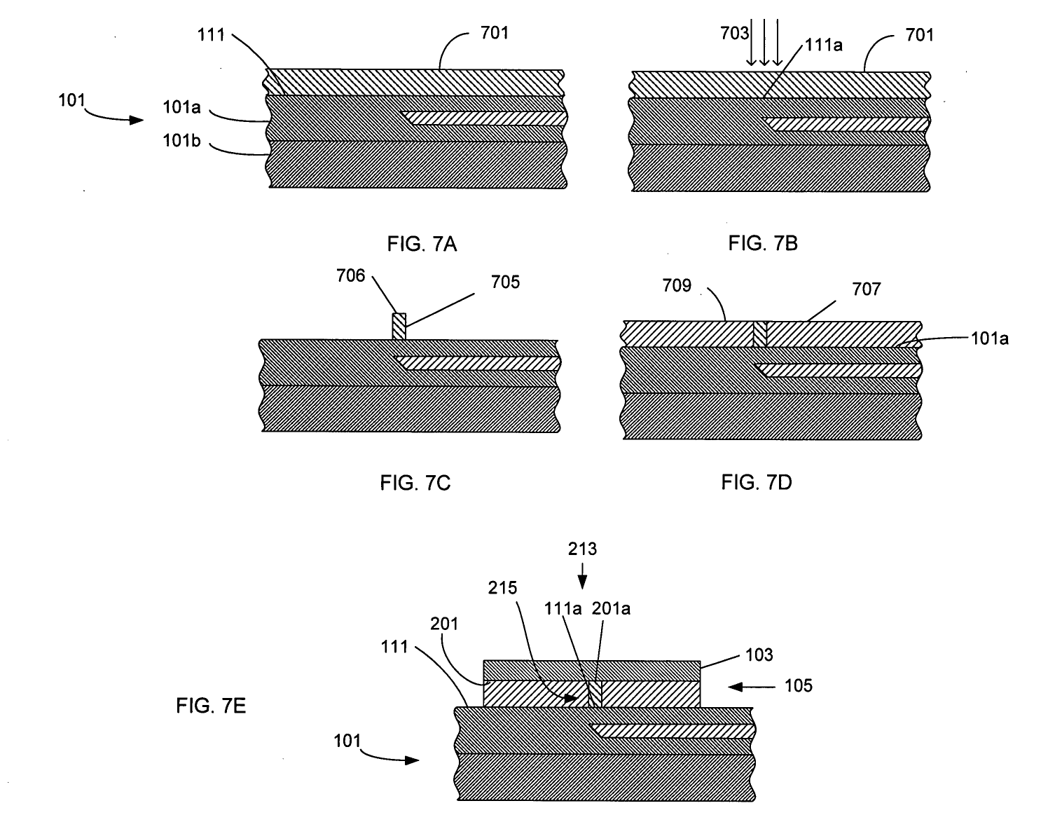

The optical connections described above can be manufactured using techniques that are compatible with semiconductor manufacturing techniques. FIGS. 7A-7E illustrate a method for manufacturing the embodiment of FIG. 4. As shown in FIG. 7A, a layer of a photosensitive optical polymer 701 is first deposited onto optical substrate layer 101a. Polymer 701 is applied using techniques known in the field, such as spin coating or curtain coating. After coating, photosensitive polymer 701 is partially cured to make the material, which is a liquid when deposited, sufficiently solid to work with. Partially curing is generally performed by soft baking. Depending on the polymer, soft baking is typically in the range of from about 80° C. to about 100° C.

As shown in FIG. 7B, photosensitive polymer 701 is next exposed to patterned actinic radiation 703 to further cure selected areas of the polymer. Selective curing at portions corresponding to the desired locations waveguides 215 is accomplished by exposing polymer 701, using a mask (not shown) in regions above optically active areas 111b. The unexposed polymer is then removed by an etching process, such as wet etching, leaving a core 705 with a core end 706 as illustrated in FIG. 7C. A layer of polymer 707, preferably a heat-curable polymer, is then applied to surface 101a using any suitable method such that it surrounds core 705 and extends near the top of core end 706. Polymer 707 is then cured, for example by heating to a temperature typically from about 150° C. to about 180° C.

Next, polymers 701 and 707 are polished to form a polished surface 709 as illustrated in FIG. 7D, where the polishing can be performed by mechanical polishing, preferably chemical mechanical polishing. Finally, optically active areas 201a of device 103 are aligned with core ends 706 and surfaces 201 and 111 are joined together, for example by bonding, as shown in FIG. 7E. Bonding can be performed by applying a very thin layer of a heat curable optical polymer on one of surfaces to be joined, and then curing the layer after the substrates have been aligned. Preferably, the bonding layer is less than about 1 μm thick.

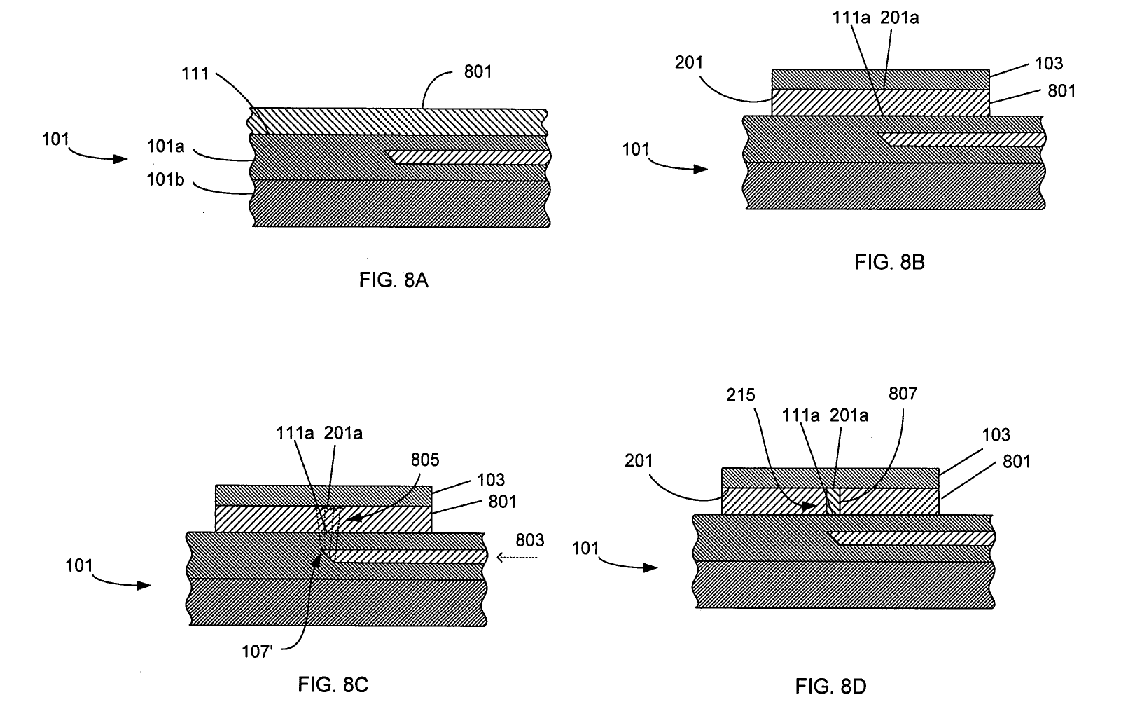

FIGS. 8A-8D illustrate another method of making the embodiment of FIG. 4. As shown in FIG. 8A, photobleachable polymer 801 is first coated onto optical substrate layer 101a. Polymer 801 may be coated onto substrate 101a as previously described. Next, polymer 801 is soft baked to partially cure the polymer. As shown in FIG. 8B, device 103 is placed on polymer 801 with opposing optically active areas aligned. Next the photobleachable polymer 801 is exposed to actinic radiation, such as UV light, in the area between the optically active surfaces to cause the refractive index in the exposed area to change. FIG. 8C illustrates a UV light beam 803 propagated through waveguide 107′ and through polymer 801 as beam 805. The wavelength and exposure of beam 803 depends on the bleaching properties of polymer 801 and the required change in refractive index. Polymer 801 is then heated to fully cure layer 105, as shown in FIG. 8D. In an alternative method, device 103 may be joined to polymer layer 801 after the photobleaching and curing steps are completed.

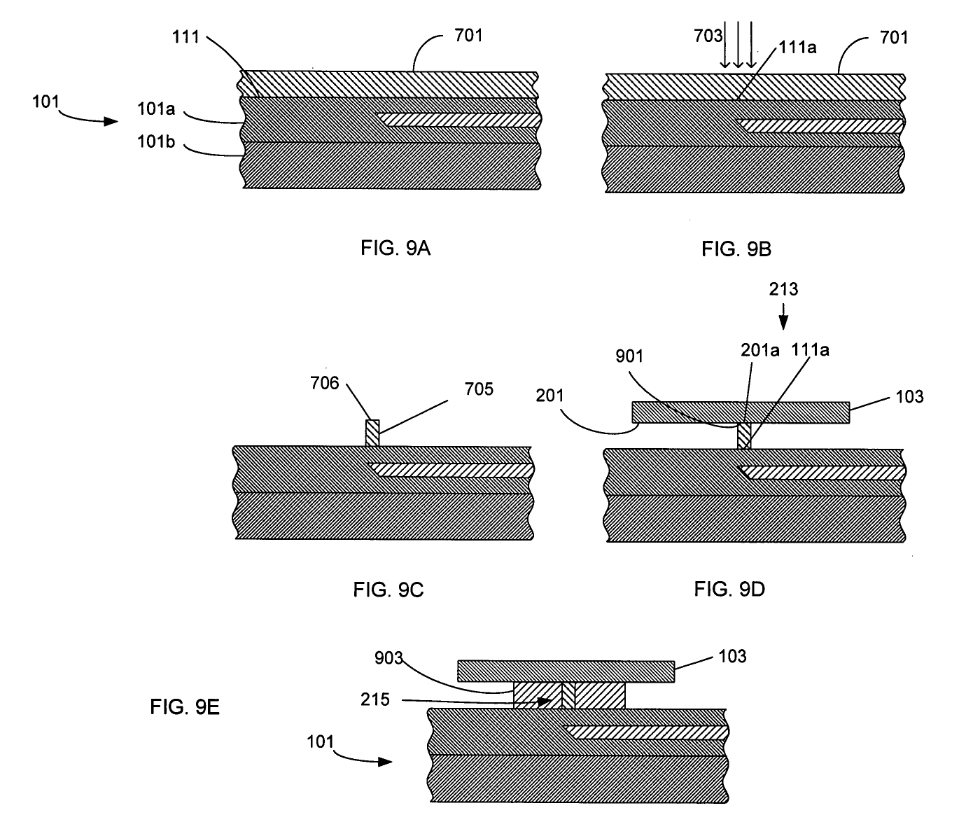

FIGS. 9A-9E illustrate a method for manufacturing the embodiment of the present invention of FIG. 5. The steps up to and including the etching of the core as shown in FIGS. 9A-9C, are similar to the steps described reference to FIGS. 7A-C. The next step is illustrated in FIG. 9D, wherein core end 706 is polished, and areas 111a of substrate 101 and area 201a of device 103 are aligned. Optionally, an adhesive 901 may be placed on core end 706 for bonding the core end to component 103. Finally, a heat-curable polymer 903 fills the gap between the substrates in the area around core material 705, and polymer 903 is cured.

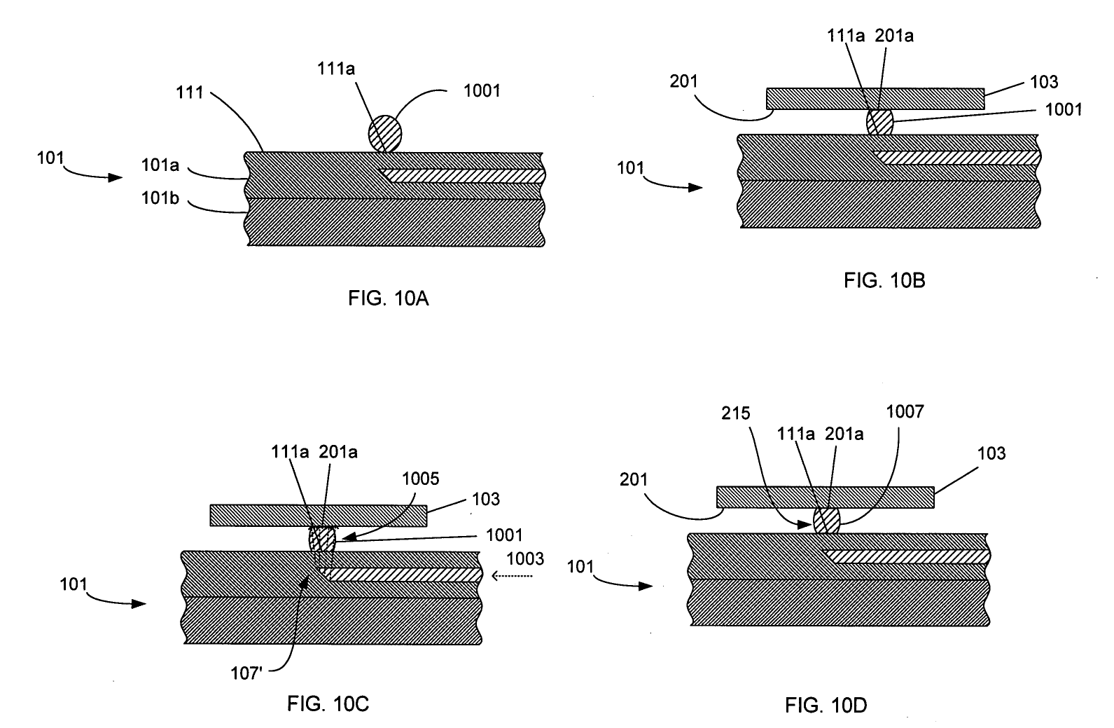

FIGS. 10A-10D illustrate a method for manufacturing the embodiment of FIG. 6. As shown in FIG. 10A, a ball 1001 of a photobleachable polymer, is placed on optically active area 111a and is soft baked to partially cure the polymer. As shown in FIG. 10B, component 103 is placed on polymer ball 1001 with opposing optically active areas aligned. The area of polymer ball 1001 between pairs of optically active surfaces is then exposed to actinic radiation to modify the refractive index. FIG. 1C illustrates a UV light beam 1003 propagated through waveguide 107′ and through the interior volume of polymer ball 1001 as beam 1005. Polymer ball 1001 is then heated, as described previously, to fully cure the polymer.

The present invention thus provides a device and method for connecting two optical substrates. The embodiments described above are illustrative of the present invention and are not intended to limit the scope of the invention to the particular embodiments described. Accordingly, while one or more embodiments of the invention have been illustrated and described, it will be appreciated that various changes can be made therein without departing from the spirit or essential characteristics thereof. For example, while the present invention describes the use of certain optical polymers, other polymers or combinations of polymers may be used. Accordingly, the disclosures and descriptions herein are intended to be illustrative, but not limiting, of the scope of the invention, which is set forth in the following claims.

1. An apparatus for transmitting light comprising:
a first substrate having a first surface including at least one first optically active area;
a second substrate having a second surface positioned in opposing spaced apart relationship from said first surface, where said second surface has at least one second optically active area opposing said at least one first optically active area; and
a waveguide between said first and second optically active areas on said first and second surfaces, where said waveguide comprises a polymer core and a cladding for transmitting light therebetween.

2. The apparatus of claim 1, wherein said cladding comprises a second polymer, and wherein said first polymer is a photosensitive polymer.

3. The apparatus of claim 2, wherein said first polymer comprises a fluorinated polymer.

4. The apparatus of claim 1, wherein said first substrate is an optical circuit board.

5. The apparatus of claim 1 wherein each of said first and second substrates comprise a plurality of optically active areas.

6. The apparatus of claim 1 wherein the space between said first and second substrates is substantially filled with polymeric material.

7. The apparatus of claim 6 wherein one or more additional structures are embedded within said polymeric material.

8. The apparatus of claim 1, wherein said first and second surfaces are substantially parallel and spaced apart by a distance which is in the range of about 0.02 mm to about 0.15 mm.

9. The apparatus of claim 4, wherein said second substrate is an IC.

10. The apparatus claim 4, wherein said second substrate is a waveguide daughter board.

11. The apparatus of claim 1 wherein one of said optically active areas comprises a photodiode.

12. The apparatus of claim 1 wherein one of said optically active areas comprises a semiconductor laser.

13. A method of forming an optical interconnect between optically active areas on opposing surfaces of first and second spaced-apart substrates, comprising:
forming one or more waveguide cores on optically active areas of the first substrate from a photosensitive optical polymer, where said cores protrudes from said first substrate and have ends distal said substrate;
forming a waveguide cladding around said waveguide cores from a second polymer; and
joining said second substrate to said distal ends of said waveguide cores after aligning optically active areas on second substrate with said waveguide cores.

14. The method claim 13, where said step of forming waveguide cores comprises:
coating at least a portion of said first substrate including with said photosensitive polymer;
partially curing said photosensitive polymer;
further curing selected areas of said photosensitive polymer using actinic radiation; and
removing the unexposed portions of said polymer.

15. The method claim 14, wherein said step of partial curing comprises soft baking.

16. The method claim 14, where said step of forming said waveguide cladding comprises:
coating at least a portion of said substrate surrounding said waveguide core with said second polymer; and
curing said second polymer.

17. The method of claim 16, wherein said cladding polymer is cured by heating.

18. The method of claim 13, further comprising the step of polishing said distal ends prior to joining them to said second substrate.

19. The method of claim 13, wherein said step of aligning precedes said step of forming said cladding.

20. The method of claim 13, wherein the opposing surfaces of said first and second substrates are about 0.02 mm to about 0.15 mm apart after being joined.

21. The method of claim 13, wherein said first substrate is an optical circuit board.

22. The method of claim 21, wherein said second substrate is an IC.

23. The method of claim 13, wherein at least one of said optically active areas comprises a photodiode, a semiconductor laser, or a light emitting diode.

24. The method of claim 13, wherein polymeric waveguide core material and polymeric cladding material occupies substantially the entire space between said opposing surfaces.

25. A method of forming an optical interconnect between optically active areas on spaced-apart opposing surfaces of first and second substrates, comprising:
depositing a photobleachable polymer over the optically active areas on said first substrate;
partially curing said photobleachable polymer;
emitting actinic radiation from the optically actives areas on said first substrate to modify the refractive index of the overlying portions of said photobleachable polymer thereby forming waveguide core regions within said polymer; and
aligning the optically active areas on said second substrate with the waveguide core regions within said polymer,
joining said second substrate to said polymer.

26. The method of claim 25, wherein said step of bonding said second substrate comprises curing said polymer.

27. The method claim 25, wherein said polymer occupies substantially the entire volume between the opposing surfaces of said first and second substrates.

28. The method of claim 25 wherein said step of depositing a photobleachable polymer over the optically active areas on said first substrate comprising depositing a polymer ball over each optically active area.

29. The method of claim 25, wherein said opposing surfaces of said first and second substrates are generally planar and are spaced apart by a distance within the range of about 0.02 mm to about 0.15 mm.

30. The method of claim 25, wherein one substrate is an optical circuit board.

31. The method of claim 30, wherein the other substrate is an IC.

32. The method of claim 30, at least one of said optically active areas comprises a photodiode, a semiconductor laser or a light emitting diode.
